(19) United States
(12) Patent Application Publication
(10) Pub. No.: US 2024/0347797 A1
(43) Pub. Date: Oct. 17, 2024

(54) Detection System and Method

(71) Applicant: QinetiQ Limited, Hampshire (GB)

(72) Inventor: Charles Yianni Cummings, Gosport, Hampshire (GB)

(21) Appl. No.: 18/580,287

(22) PCT Filed: Jul. 26, 2022
(86) PCT No.: PCT/EP2022/070853

§ 371 Date: Jan. 18, 2024

(30) Foreign Application Priority Data
Jul. 29, 2021 (GB) 2110942.6

(51) Int. Cl. H01M 10/48; H01M 50/124; H01M 50/358

(52) U.S. Cl. CPC H01M 10/486; H01M 50/1245; H01M 50/358; H01M 2200/10

(57) ABSTRACT

An early warning detection system for detecting battery thermal runaway in a battery pack or module, said system comprising a coating applied to the outside of one or more battery pack cells, said coating selected such that it decomposes at a temperature range useful for said detection and so as to emit a detectable volatile compound. Also provided is a method for preparing battery cells for use in a detection system, systems and batteries prepared according to the invention and their use in the detection of battery thermal runaway.

The present invention relates to a system and method to provide early detection of thermal runaway of battery cells, in particular within large battery module and pack such as those used in electric vehicles or stationary storage. The system and method are designed to enhance safety for the operator and maintainers. In particular the present invention relates to early detection of battery thermal runaway using gas identification from volatised coatings.

Improved performance of modern battery technologies has led to their utilisation within a number of applications. Key applications include: (1) stationary storage, (2) portable electronics and (3) electric vehicle (EV) and plug-in hybrid electric vehicle (PHEV). Both EV and PHEV require large battery packs to achieve reasonable vehicle range to compete against traditional powertrains within the automobile market. For products to meet and exceed market expectations high battery performance, such as high battery specific energy and power, infer that the technology of choice is rechargeable lithium-ion batteries.

Lithium-ion cells are charged to de-lithiate the cathode and store lithium at the anode typically giving voltage of >3 V. During discharge an external load circuit is connected and lithium (in the anode) oxidised to donate an electron to the cathode (via the circuit) causing lithium insertion and giving rise to the battery's capacity. Improvements in battery performance, either higher voltage or more capacity, has led to higher specific energy stored in battery packs. This high energy storage in combination with the flammable cell components such as electrolyte solvents and flammable cell materials raises safety concerns particularly for potential consequences of battery thermal runaway.

Battery thermal runaway is the decomposition of internal battery cell components and chemicals causing an uncontrollable self-heating process. Battery thermal runaway is induced by mechanical, electrical or thermal cell abuse causing internal short circuiting. The cell will undergo self-heating through the accelerated breakdown of internal components. This results in an exponential increase in temperature which will lead to the eventual ignition of flammable cell components. If one cell in a battery pack fails and undergoes thermal runaway then the heat generated from this cell will initiate thermal runaway in surround battery cells. This process will propagate to neighbouring cells until all undergo thermal runaway giving rise to battery pack thermal runaway.

To increase battery pack system safety the early detection of thermal runaway is critical as it will allow a longer time for mitigation actions to be taken to protect personnel safety and infrastructure. Mitigations such as personnel vacating the vicinity, notifying the emergency services, isolating the shorting cell or providing fire suppressants or additional cooling could be employed.

To monitor cell temperature in battery packs and to detect thermal runaway thermocouples are commonly used. These are positioned on the surface of the cell and temperature constantly monitored by the battery management system. This has the advantage of taking temperature measurement directly at the battery and detecting self-heating. However, it is limited in that it is not economically feasible to monitor all of the cell surface nor all cells of a large battery pack due to thermocouple cost, complexity of system integration and data processing. Battery module and pack manufacturers typically employ thermocouples at strategic locations where a select few battery cells are temperature monitored. If battery cell thermal runaway occurs away from these select locations then the detection will be delayed until the thermal runaway propagates through multiple cells to reach a thermocouple. This limitation can severely delay the detection of a battery thermal runaway.

Battery voltage measurement is another method to detect thermal runaway. The detection of a large voltage drop may indicate a short circuit however, the magnitude of the change in voltage is dependent upon a number of factors including: battery cell chemistry, battery cell design and nature of short (hard or soft short). Due to the variability of this detection method it is limited in the early detection of battery thermal runaway.

Another method of identifying thermal runaway early includes gas sensing. This utilises gas sensors such as non-dispersive infra-red (NDIR) and semiconductor sensors to detect CO₂ from the combustion of battery cells. This method allows detection of thermal runaway, while avoiding excessive use of thermocouples. However, sensing of CO₂ is only possible after cell ignition which occurs during the latter stages of thermal runaway. This method cannot detect the early stages of battery thermal runaway.

It is therefore desired to provide an alternative to the prior art that overcomes or mitigates problems or issues therewith. It is against this background that the invention has been devised. A system and method to detect self-heating at temperatures relevant for thermal runaway diagnosis is provided. This avoids the complexity of integrating, connecting and monitoring thermocouples on every cell over all of its surface, while maintaining system performance to detect first cell thermal runaway. This early warning would be of value to increase safety of large battery packs such as those used as uninterruptable power supplies (UPS) in stationary storage or in EV and PHEV.

According to the present invention it has been found that coating battery cells in a coating composed of a polymer or composite film that will emit a detectable chemical upon heating provides an early warning detection system. According to a first aspect of the present invention there is provided an early warning detection system for detecting battery thermal runaway in a battery pack or module, said system comprising a coating applied to the outside of one or more battery pack cells, said coating selected such that it decomposes at a temperature range useful for said detection and so as to emit a detectable volatile compound.

In one embodiment the battery thermal runaway comprises a self-heating and combustion propagation of Lithium-ion battery components within a battery pack or module.

Suitably, the early warning is likely to be at least an order of magnitude quicker detection of battery thermal runaway due to battery cell level detection rather than the module level detection (likely to be ˜1 min instead of ˜10 min).

In one embodiment the coating applied to said battery cells is composed of intrinsic and composite materials including: polymer and non-polymer functional materials; such as: charcoals, ion exchange resins and metal organic frameworks.

In one embodiment one or more of gas sensors are located in the headspace or close vicinity of the battery pack for emitted chemical detection.

In one embodiment one or more gas sensors are located at the ventilation inlet or away from the headspace (not close vicinity of the battery pack) to monitor ambient concentration of emitted chemical to avoid false positives.

In one embodiment the polymer coating emits a volatile compound such as volatile organic compound (VOC) or a volatile inorganic compound.

In one embodiment the coating is composed of polymer or composite polymer coating is poly(amide), poly(carbonate), poly(etheretherketone), poly(etherimide), low density poly(ethylene), high density poly(ethylene), ultra-high molecular weight poly(ethylene) & poly(ethylene terephthalate), poly(methyl methacrylate), poly(styrene), poly(lactic acid) and the like.

In one embodiment the sensor is a photo ionising sensor (PID). In one embodiment the sensor is a semiconductor gas sensor.

In one embodiment the minimum cell temperature required to allow early detection is greater than 100° C.

In one embodiment the system can be used in without or in combination with current thermal runaway detecting technologies including thermocouples and voltage measurements

In one embodiment said coatings can be applied to newly manufacture (pristine) cells from original equipment supplier or engineering re-seller or used (retrofit) battery cells.

In one embodiment the battery is a primary or secondary lithium and lithium-ion battery. In one embodiment the battery is cylindrical, prismatic or pouch configuration. In one embodiment the battery is located either in a ventilated or non-ventilated configuration.

In one embodiment the battery is located in a battery module or battery pack. In one embodiment the battery is a high power or high energy battery.

In one embodiment the VOC or volatile inorganic compound emitted and detected is selected from one or more of the following: acetic acid, acetone, acetophenone, acetylene, acrolein (2-propen-1-one), benzaldehyde, benzene, benzoic Acid, buta-1,3-diene, butan-1-ol, butan-2-ol, butan-2-one, 2-butoxyethanol, carbon dioxide, carbon monoxide, chlorine, decamethylcyclopentasiloxane, decane, 1,2-dibromoethane, 2,6-ditertbutylphenol, 2,6-ditertbutyl-4-methylphenol, dichloroacetylene, 4-dichlorobenzene, dichloromethane, difluoromethane, dodecane, ethanol 2-ethoxyethanol, ethylacetate, ethylbenzene, ethyltoluenes (o-, m-), hexamethylcyclotrisiloxane, n-hexane, 2-hexanone, hydrogen, hydrogen bromide, hydrogen chloride, hydrogen cyanide, hydrogen fluoride, hydrogen sulphide, limonene, methane, methanol, 2-methoxyethanol, 1-methoxy-2-propanol, 2-methyl-1,3-butadiene, methyl butane, methyl cyclohexane, methyl methacrylate, 1-methylnaphthalene, 4-methyl-2-pentanone, 2-methyl propanol, naphthalene, nitrogen dioxide, nitrogen monoxide, nonane, ocatamethylcyclotetrasiloxane, pentafluoroethane, phenol, 2-propanol, propylbenzene, styrene, sulphur dioxide, tetrachloroethylene, tetrachloromethane, 1,1,1,2-tetrafluoroethane, toluene, triarylphosphates, trichloroethane (1,1,1-, 1,1,2-), trichlororethylene, trichloromethane, trichlorofluoromethane, trimethylbenzenes (1,2,3-, 1,2,4-, 1,3,5-), trimethylsilanol, undecane, vinylidene chloride and xylenes (o-, a- p-) and such like.

In one embodiment the coatings can be applied via standard film formation coatings including: painting, dip coating, spray deposition, liquid deposition, physical attachment and the like.

In a further aspect the present invention provides systems and batteries for use in methods for detection of thermal runaway in which the advantage over current battery thermal detection technologies derives from complete coverage of cells that can be attained via coating material (opposed to selective locations for thermocouple placement) and low system integration/manufacturing cost.

In a further aspect, the present invention provides the use of a system or battery in a method of detection of thermal runaway in battery of original equipment manufacturers (OEM), system integrators with applications in automotive, aerospace, defence, oil and gas, stationary storage, medical, consumer applications and the like.

The detection method of the present invention can also be utilised in combination with other detection methods as appropriate. The features of any aspect or embodiment of the invention may be used, alone or in combination, with other aspects and embodiments as appropriate.

The invention will now be described in more detail and by way of example only, with reference to the following Schematic Figures, in which:

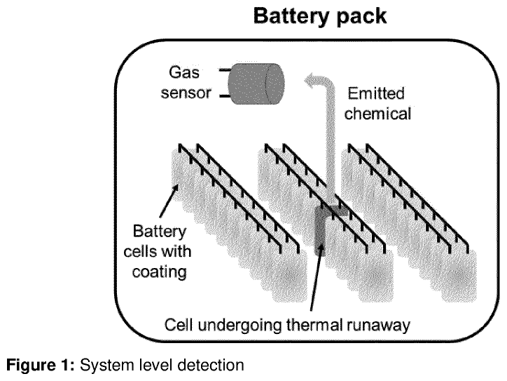

FIG. 1 shows the system level detection of the invention. The figure shows a battery pack composed of three battery modules each containing 10 battery cells with the invention coating. A battery cell (in the middle of the battery pack) is undergoing a thermal runaway volatilising the coating chemicals. The emitted chemicals under mass transport (diffusion and convection) are transported away from the battery cell and are detected by a commercial off the shelf gas sensor located in the headspace (or vicinity) of the battery pack.

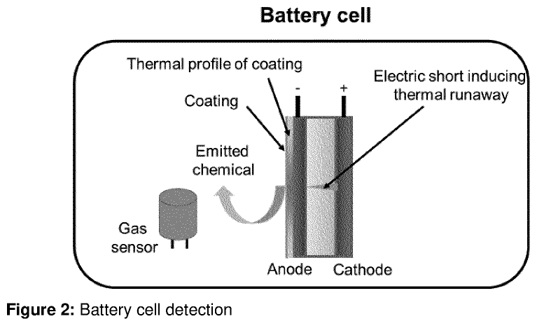

FIG. 2 shows the battery cell detection of the invention. The figure shows the internal components of the battery cell which is composed of anode, cathode with electrical connections. On the outside of the battery cell is the invention coating. An electrical short inducing thermal runaway is formed (as a short circuit) between the anode and cathode. This causes localised heating of the battery cell and volatisation of chemicals within the invention coating. The volatised chemicals undergo mass transport to be detected by the gas sensor.

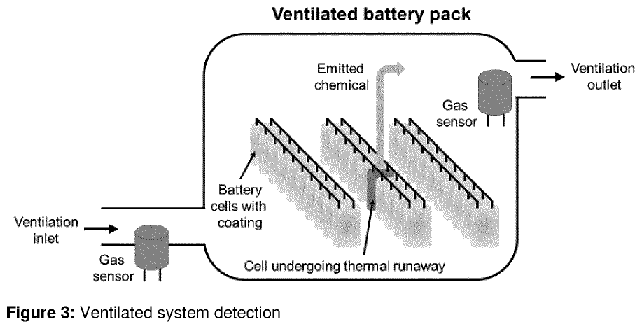

FIG. 3 shows ventilated system detection of the invention. The figure shows a ventilated battery pack whereby air is forced into the battery pack to cool the cells. The battery pack is composed of 3 battery modules containing 10 battery cells each. One of the battery cells is undergoing thermal runaway to emit chemical as before. The chemicals emitted are detected by the gas sensor located before the ventilation outlet. The gas sensor at the ventilation inlet provides a background monitor of cross contamination chemicals that could be present in the atmosphere to interfere with the battery thermal runaway process.

### DETAILED DESCRIPTION

Battery cells undergoing thermal runaway will have surface temperatures of >100° C. during the initial stages. The invention concerns a coating for battery cells that volatises chemicals during this heating process. The emitted chemicals can result from the chemical breakdown of the coating, release of chemicals from the coating present from the preparation process and/or release of chemicals adsorbed within the coating. The volatised chemicals can be detected in the gas phase via gas sensors that are either in the headspace or vicinity of the battery pack. The coating can be applied to all cells giving 100% coverage. The sensitivity of the detection of the coating can be tailored depending on the physical and chemical properties of the coatings. The gases emitted can be detected via commercial off the shelf gas monitors. Further details for systems according to the invention are provided below.

### Polymer and Composite Films

Degradation coatings could be polymers, charcoals or functional chemicals such as metal organic frameworks or composites alike. A list below includes commercially available polymers that could be utilised within the coatings. It is not an exhaustive list as there are many different coating materials that could be applied. Out of these materials poly(methyl methacrylate) and poly(styrene) have suitable decomposition temperatures (between 100° C.-150° C.) applicable to monitor battery thermal runaway. At these temperatures polymers will emit detectable chemicals. Alternative materials that could be utilised include charcoal and metal organic framework coatings with a pre-adsorbed chemical that could be emitted upon heating.

TABLE 1
Polymers to be employed in coatings
for chemical emission upon heating

| | | |
|---|---|---|
| Polymethyl methacrylate | Polystyrene (PS)—tested | Polylactic acid |
| (PMMA)—tested and | and worked | (PLA) |
| worked | | |
| Polyamide e.g. Nylon 6 | Polycarbonate (PC) | Polyetherether- |
| | | ketone (PEEK) |
| Polyetherimide (PEI) | Polyetheylene (low (LDPE), | Polyethylene |
| | high density (HDPE), ultra- | terephthalate |
| | high molecular weight | (PET) |
| | (UHMWPE)) | |

### Emitted Species and Gas Detection

Different coatings will emit various volatile organic compounds (VOCs) or inorganic chemicals. Both types of chemicals can be detected via commercially available gas sensors including: electrochemical, semiconductor, infrared and photo-ionisation (PID) gas sensors.

Generally speaking the emitted chemicals from polymers can be categorised into two groups:
(1) monomers of the polymer or
(2) decomposition chemical.

The monomers originate from the polymers themselves and include for example: styrene and methyl methacrylate, for polymethyl methacrylate and polystyrene respectively.

The decomposition chemicals are likely to be simple chemicals from the oxidation of the polymeric species.

The composition of the emitted chemicals and will be dependent upon the composition of the film (polymer or composite) and the temperature it is exposed to. This could also include impregnating a coating with an emission chemical.

A list of various potential VOC and inorganic emitted chemicals that could be sensed include those are listed below:

TABLE 2
VOC emitted from coating materials

| | | |
|---|---|---|
| Acetic Acid | Acetone | Acetophenone |
| Acetylene | Acrolein (2-propen- | Benzaldehyde |
| | 1-one) | |
| Benzene | Benzoic Acid | Bromotrifluoromethane |
| Buta-1,3-diene | Butan-1-ol | Butan-2-ol |
| Butanolamine | Butan-2-one (Methyl | 2-Butoxyethanol |
| | ethyl ketone) | |
| Carbon Dioxide | Carbon Monoxide | Chlorine |
| Decamethyl- | Decane | 1,2-Dibromoethane |
| cyclopentasiloxane | | |
| 2,6-Ditertbutylphenol | 2,6-Ditertbutyl-4- | Dichloroacetylene |
| | methylphenol | |
| 1,4-Dichlorobenzene | Dichloromethane | Difluoromethane |
| Dodecane | Ethanol | 2-Ethoxyethanol |
| 2-Ethoxyethylacetate | Ethylacetate | Ethylbenzene |
| Ethyltoluenes (o-, m-) | 1,1,1,3,3,3- | Hexamethyl- |
| | Hexafluoropropane | cyclotrisiloxane |
| n-Hexane | 2-Hexanone | Hydrazine |
| Hydrogen | Hydrogen bromide | Hydrogen chloride |
| Hydrogen cyanide | Hydrogen fluoride | Hydrogen sulphide |
| Hydrogen ammonium | Limonene | Methane |
| perchlorate | | |
| Methanol | 2-Methoxyethanol | 1-methoxy-2-propanol |
| 2-Methyl-1,3-butadiene | Methyl butane | Methyl cyclohexane |
| 1-Methylnaphthalene | 4-Methyl-2- | 2-Methyl propanol |
| | pentanone | |
| Monoethanolamine | Napthalene | Nitrogen dioxide |
| Nitrogen monoxide | Nonane | Ocatamethyl- |
| | | cyclotetrasiloxane |
| Pentafluoroethane | Phenol | 2-Propanol |
| Propylbenzene | Iso-Propylene glycol | Styrene |
| | dinitrate | |
| Sulphur dioxide | Tetrachloroethylene | Tetrachloromethane |
| 1,1,1,2-Tetrafluoroethane | Toluene | Triaryl phosphates |
| 1,1,1-Trichloroethane | 1,1,2- | Trichlororethylene |
| | Trichloroethane | |
| Trichloromethane | Trichlorofluoro- | Trimethylbenzenes |
| | methane | (1, 2, 3-, 1, 2, 4-, |
| | | 1, 3, 5-) |
| Trimethylsilanol | Undecane | Vinylidene chloride |
| o-Xylenes | a-Xylenes | p-Xylenes |

### Polymer Combustion and Analysis

Two example polymers were experimented upon due to their suitable thermal properties for decomposition within the target temperature range 100-200° C. (ca. poly(styrene) and poly(methyl methacrylate)) which is crucial for the detection of battery thermal runaway. Both are commercially available thermoplastics that were sourced from Goodfellows, UK.

To undertake degradation experimentation, each polymer film was cut into a ˜1 cm² sample and placed within a sealed glassware apparatus and an evacuated Tedlar gas bag attached. The polymer was heated at selected temperature for 2 min. The system was subsequently flushed with 1 dm³ of compressed air and collected in the Tedlar gas bag for analysis.

Diluted gas within the Tedlar gas bag was then sampled onto Carbopack TD-1 sample tubes (Markes International) for chemical analysis. Tubes were loaded onto the thermal desorption (TD) unit and analysed by gas chromatography/mass spectrometry (GC/MS) to identify emitted chemicals and their concentration (Thermo Fisher Scientific).

During experimentation shown here three repeats were performed with differing sample volumes taken onto the Carbopack TD-1 tubes ca. 100 mL, 200 mL and 400 mL.

TABLE 3
Masses of decomposition acetamide and phenol of polystyrene
released at various temperatures and gas sample volumes

| Decom- | | Acetamide | | Phenol | |
|---|---|---|---|---|---|
| position | Sample | Tube | Polymer | Tube | Polymer |
| Temperature | Volume | loading | emission | loading | emission |
| (° C.) | (mL) | (ng · tube⁻¹) | (ng · cm⁻²) | (ng · tube⁻¹) | (ng · cm⁻²) |
| 70 | 100 | 0 | 0 | 14.6 | 155.7 |
| | 200 | 0 | 0 | 18 | 96 |
| | 400 | 0 | 0 | 0 | 0 |
| 110 | 100 | 0 | 0 | 20.3 | 216.1 |
| | 200 | 32.9 | 160.2 | 21 | 171.4 |
| | 400 | 60.2 | 175.1 | 64.4 | 111.6 |
| 150 | 100 | 29.6 | 314.7 | 22.9 | 244.4 |
| | 200 | 57.3 | 305.3 | 49.1 | 261.6 |
| | 400 | 100.2 | 266.7 | 83.7 | 222.8 |
| 175 | 100 | 45.2 | 481.2 | 51.6 | 549 |
| | 200 | 41.1 | 437.6 | 41 | 436.7 |
| | 400 | 99.3 | 264.3 | 86.3 | 229.9 |

### Polymer_1 (Polystyrene)

Numerous volatile organic chemicals (VOC) were emitted from polymer_1
The two most predominant were: Chemical_1 & Chemical_2
Chemical_1 (Acetamide)
Chemical_2 (Phenol)
Linear emission of Chemical_1 and Chemical_2 observed
Repeat experiments were undertaken using different polymer_1 film thickness and the same effect observed
At 150° C., approximately 300 ng.cm⁻² of Chemical_1 and Chemical_2 were emitted both of which can be detected in the gas phase via semiconductor and PID gas sensors.

### Polymer_2 (Polymethyl Methacrylate)

A single predominant VOC was emitted from polymer_2, Chemical_3 (methyl methacrylate)
Transition occurs whereby Chemical_3 was significantly emitted between 110 and 150° C.
Increased from ˜150 ng.cm⁻² at 110° C. and ˜1300 ng.cm⁻² at 150° C. (10-fold increase)

TABLE 4
Masses of decomposition methyl methacrylate released
at various temperatures and gas sample volumes

| | | Methyl Methacrylate | |
|---|---|---|---|
| Decomposition | Sample | | Polymer |
| Temperature | Volume | Tube loading | emission |
| (° C.) | (ml) | (ng · tube⁻¹) | (ng · cm⁻²) |
| 70 | 100 | 0 | 0 |
| | 200 | 14.6 | 77.9 |
| | 400 | 19.9 | 53.1 |
| 110 | 100 | 19 | 202.6 |
| | 200 | 25.7 | 137 |
| | 400 | 39.4 | 104.8 |
| 150 | 100 | 123.8 | 1318.9 |
| | 200 | 232.9 | 1240.4 |
| | 400 | 469.6 | 1250.4 |
| 175 | 100 | 151 | 1608.5 |
| | 200 | 301.4 | 1604.9 |
| | 400 | 637.8 | 1698.2 |

### Gas Detection Headspace Modelling

Battery cells can be enclosed within a sealed system. Headspace modelling is conducted to determine the sensitivity of this detection system to battery thermal runaway within this configuration.

All 3 VOCs emitted by the tested coatings (polymethyl methacrylate and polystyrene) can be detected by a commercial semiconductor and PID gas sensors (lamp≥10 eV). The PID gas sensors response of all 3 VOCs is higher than isobutylene which is PID standard detection gas.

Vapour concentrations were modelled for Chemical_3 within various headspace volumes
A commercially sourced photo-ionisation detector could identify Chemical_3 (1 cm²) emission at 150° C. up to ˜16 dm³ headspace. (PID-AH2 sensitivity—1 ppb).
“Emission transition” and large emission increase detection sensitivity (earlier warning) and selectivity (reduce false negatives/positives)

### Gas Detection in Ventilated System Modelling

Batteries can be assembled into ventilated systems. Ventilation system modelling can be undertaken to estimate the sensitivity of this detection system for battery thermal runaway within this configuration.

Modelling of the vapour concentrations of detectable VOCs in ventilated systems with various gas exchange rates can be undertaken with attained data. The model used the following assumptions:
‘Fixed’ assumptions—Sealed, homogenous system (apart from air flows), PID sensor on outlet, Instantaneous VOC emission at T=0, No cross contaminants, 1^{st} order chemical mixing
‘variable’ assumptions—Total cabinet volume, 2 m³, Cabinet headspace, 0.1 m³, 10 cm² cell area heated @ 150° C., (˜16 cm² surface area for 18650)
   Gas sensor—PID
      Limit of detection (LoD) for chemical_3=0.04 mg.m⁻³, ˜10 ppb
   VOC concentration modelling for ventilated systems
      Modelling predicts detection response and sensor suitability
   Time and gas hourly space velocity (GHSV) dependence on VOC concentration
      VOC concentration exponentially decays with time due to mixing
      Increasing GHSV decreases the VOC concentration
   Heated surface area and GSHV dependence on VOC concentration at 1 minute
      Increasing heated surface area increases VOC concentration
      Increasing GHSV decreases the VOC concentration
   Summary
      Sophisticated models can explore the effect of:
         External contaminant interference
         Different designs of battery storage
         Different internal flows
      Model verification with experimental data

TABLE 5
Ventilated system modelling with
a Gas hourly space velocity of 1 h⁻¹

| Time | Fresh air | Dilution | Concentration |
|---|---|---|---|
| (min) | volume (m³) | Factor | (mg · m⁻³) |
| 0 | 0.00 | 0.00 | 0.24 |
| 1 | 0.03 | 0.33 | 0.17 |
| 2 | 0.07 | 0.67 | 0.12 |
| 3 | 0.10 | 1.00 | 0.09 |
| 4 | 0.13 | 1.33 | 0.06 |
| 5 | 0.17 | 1.67 | 0.05 |
| 6 | 0.20 | 2.00 | 0.03 |
| 7 | 0.23 | 2.33 | 0.02 |
| 8 | 0.27 | 2.67 | 0.02 |
| 9 | 0.30 | 3.00 | 0.01 |
| 10 | 0.33 | 3.33 | 0.01 |

### System Integration

The detection of thermal runaway of battery cells within battery packs or modules that are either ventilated and non-ventilated systems can be achieved via the integration of the gas detection system.

For non-ventilated system the coating is to be applied to all battery cells. The gas sensor is to be placed within the headspace of the enclosed environment. One or more gas sensors can be utilised to improve gas sensing properties. Air circulation can be undertaken to improve detection.

For ventilated systems the gas sensors can be placed at strategic locations within the battery packing including the inlet of ventilation, the outlet of the ventilation and in close proximately to the batteries themselves if required.

For both systems gas sensors can be located outside of the battery pack and can be used to monitor ambient concentration of contaminants that could interfere with the detection of emitted gases.

A data processing system can collect data from gas sensors and determine if the chemicals are emitted within the battery pack or from an external contamination.

1. An early warning detection system for detecting battery thermal runaway in a battery pack or module, said system comprising:
a coating applied to the outside of one or more battery pack cells, said coating selected such that it decomposes at a temperature range useful for said detection and so as to emit a detectable volatile compound.

2. The system according to claim 1 wherein battery thermal runaway comprises the self-heating and combustion propagation of Lithium-ion battery components within a battery pack or module.

3. The system according to claim 1 wherein the early warning is at least an order of magnitude quicker detection of battery thermal runaway due to battery cell level detection rather than the module level detection.

4. The system according to claim 1 wherein the coating applied to said battery cells is composed of intrinsic and composite materials including:
polymer functional materials and non-polymer functional materials, wherein the non-polymer functional materials comprise at least one of: charcoals, ion exchange resins or metal organic frameworks.

5. The system according to claim 1 further comprising one or more gas sensors located in the headspace or close vicinity of the battery pack for emitted chemical detection.

6. The system according to claim 1 further comprising one or more gas sensors located at the ventilation inlet or away from the headspace (not close vicinity of the battery pack) to monitor ambient concentration of emitted chemical to avoid false positives.

7. The system according to claim 1, wherein the coating comprises a polymer coating, wherein the polymer coating emits a volatile compound such as volatile organic compound (VOC) or a volatile inorganic compound.

8. The system according to claim 1 wherein the coating comprises a polymer or composite polymer coating, wherein the polymer or composite polymer coating comprises poly(amide), poly(carbonate), poly(etheretherketone), poly(etherimide), low density poly(ethylene), high density poly(ethylene), ultra-high molecular weight poly(ethylene) & poly(ethylene terephthalate), poly(methyl methacrylate), poly(styrene), or poly(lactic acid).

9. The system according to claim 1, further comprising a sensor, wherein the sensor is a commercial-off-the shelf gas sensor.

10. The system according to claim 1, further comprising a sensor, wherein the sensor is a photo ionising sensor (PID).

11. The system according to claim 1, further comprising a sensor, wherein the sensor is a semiconductor gas sensor.

12. The system according to claim 1, further comprising a sensor, wherein the sensor is an infrared gas sensor.

13. The system according to claim 1, further comprising a sensor, wherein the sensor is an electrochemical gas sensor.

14. The system according to claim 1 wherein the minimum cell temperature required to allow early detection is greater than 100° C.

15. (canceled)

16. The system according to claim 1 wherein said coatings can be applied to newly manufactured (pristine) cells from original equipment supplier or engineering re-seller or used (retrofit) battery cells.

17. The system according to claim 1 wherein the battery is a primary or secondary lithium battery.

18. The system according to claim 1 wherein the battery is cylindrical, prismatic or pouch configuration.

19. The system according to claim 1 wherein the battery is located either in a ventilated or non-ventilated configuration.

20. The system according to claim 1 wherein the battery is located in a battery module or battery pack.

21. (canceled)

22. The system according to claim 7 wherein the VOC or volatile inorganic compound emitted and detected is selected from one or more of the following: acetic acid, acetone, acetophenone, acetylene, acrolein (2-propen-1-one), benzaldehyde, benzene, benzoic Acid, buta-1,3-diene, butan-1-ol, butan-2-ol, butan-2-one, 2-butoxyethanol, carbon dioxide, carbon monoxide, chlorine, decamethylcyclopentasiloxane, decane, 1,2-dibromoethane, 2,6-ditertbutylphenol, 2,6-ditertbutyl-4-methylphenol, dichloroacetylene, 4-dichlorobenzene, dichloromethane, difluoromethane, dodecane, ethanol 2-ethoxyethanol, ethylacetate, ethylbenzene, ethyltoluenes (o-, m-), hexamethylcyclotrisiloxane, n-hexane, 2-hexanone, hydrogen, hydrogen bromide, hydrogen chloride, hydrogen cyanide, hydrogen fluoride, hydrogen sulphide, limonene, methane, methanol, 2-methoxyethanol, 1-methoxy-2-propanol, 2-methyl-1,3-butadiene, methyl butane, methyl cyclohexane, methyl methacrylate, 1-methylnaphthalene, 4-methyl-2-pentanone, 2-methyl propanol, naphthalene, nitrogen dioxide, nitrogen monoxide, nonane, ocatamethylcyclotetrasiloxane, pentafluoroethane, phenol, 2-propanol, propylbenzene, styrene, sulphur dioxide, tetrachloroethylene, tetrachloromethane, 1,1,1,2-tetrafluoroethane, toluene, triarylphosphates, trichloroethane (1,1,1-, 1,1,2-), trichlororethylene, trichloromethane, trichlorofluoromethane, trimethylbenzenes (1,2,3-, 1,2,4-, 1,3,5-), trimethylsilanol, undecane, vinylidene chloride, or xylenes (o-, a- p-).

23. (canceled)

24. (canceled)

25. (canceled)
